(19) United States
(12) Patent Application Publication
(10) Pub. No.: US 2011/0269336 A1
(43) Pub. Date: Nov. 3, 2011

(54) ELECTRICAL EQUIPMENT SYSTEMS

(75) Inventors: Tomonobu NASHIMOTO, Anjo-shi (JP); Yan SHI, Anjo-shi (JP); Kenji ABE, Anjo-shi (JP); Munetoshi GOTO, Anjo-shi (JP)

(73) Assignee: MAKITA CORPORATION, ANJO-SHI (JP)

(21) Appl. No.: 13/088,886

(22) Filed: Apr. 18, 2011

(30) Foreign Application Priority Data
Apr. 28, 2010 (JP) 2010-103745

(51) Int. Cl. H01R 11/00

(52) U.S. Cl. 439/504

(57) ABSTRACT

An electrical equipment system may include a battery for an electrical power tool, an electrical equipment except for the electrical power tool, and an adapter that is capable of electrically and mechanically connecting the battery and the electrical equipment. The adapter has a battery side connecting portion that is capable of being detachably connected to the battery and an electrical equipment side connecting portion that is capable of being connected to the electrical equipment.

### BACKGROUND OF THE INVENTION

1. Field of the Invention

The present invention relates to electrical equipment systems and adapters used in the systems. More particularly, the present invention relates to electrical equipment systems that have electrical equipments except for electrical power tools and batteries for the electrical power tools, and adapters used in the systems.

2. Description of Related Art

Generally, a (rechargeable) battery for an electrical power tool is specially constructed for the electrical power tool and is not designed for an electrical equipment except for the electrical power tool. That is, the battery for the electrical power tool is capable of being electrically connected only to the electrical power tool and is incapable of being electrically connected to the electrical equipment except for the electrical power tool.

However, the battery for the electrical power tool is capable of withstanding a large load and has considerable durability. Further, the battery can be repeatedly used by recharging. Therefore, if the battery for the electrical power tool is capable of being electrically connected to the electrical equipment except for the electrical power tool, it is useful for such an electrical equipment.

Further, an example of the electrical equipment except for the electrical power tool is a portable light that is used in an area in which an AC source is not present. Such a portable light is taught, for example, by Japanese Laid-Open Patent Publication Number 2000-205242. The portable light is a battery-powered light in which a battery is contained in a light housing thereof. In addition, a clip is attached to the light housing. Therefore, the portable light can be secured to a desired position using the clip.

In such a portable light in which the battery is contained in the light housing thereof, the light housing must be increased in size in order to contain the battery therein. Further, the portable light thus constructed may have an increased weight for the battery. This may lead to decreased operability of the portable light. If the portable light can be electrically connected to the battery for the electrical power tool, the portable light needs not to have the battery. Therefore, if the portable light can be electrically connected to the battery for the electrical power tool, the portable light can be reduced in size and weight for the battery, so that operability of the portable light can be increased.

### BRIEF SUMMARY OF THE INVENTION

In one aspect of the present invention, an electrical equipment system may include a battery for an electrical power tool, an electrical equipment except for the electrical power tool, and an adapter that is capable of electrically and mechanically connecting the battery and the electrical equipment. The adapter has a battery side connecting portion that is capable of being detachably connected to the battery and an electrical equipment side connecting portion that is capable of being connected to the electrical equipment.

According to this aspect, the battery for an electrical power tool can be used as an electric source of the electrical equipment except for the electrical power tool. Thus, the battery can be widely used.

Further, the electrical equipment needs not have a battery therein. Therefore, the electrical equipment can be reduced in size and weight.

Optionally, the electrical equipment side connecting portion and the battery side connecting portion of the adapter can be connected to each other via an electric wire. Conversely, the electrical equipment side connecting portion and the battery side connecting portion of the adapter can be integrated with each other.

Other objects, features and advantages of the present invention will be readily understood after reading the following detailed description together with the accompanying drawings and the claims.

### BRIEF DESCRIPTION OF THE DRAWINGS

FIG. 1(A) is a perspective view of an electrical equipment system (a portable light unit) according to a first embodiment of the present invention;

FIG. 1(B) is a partially perspective view of the electrical equipment system in which an adapter is modified;

FIG. 2(A) is an exploded perspective view of FIG. 1(A);

FIG. 2(B) is an exploded perspective view of FIG. 1(B);

FIG. 3(A) is an elevational view of an electrical equipment (a portable light) of the electrical equipment system;

FIG. 3(B) is a side view of the electrical equipment (the portable light);

FIG. 3(C) is a cross-sectional view taken along line III(C)-III(C) of FIG. 3(A);

FIG. 4 is an elevational view of the electrical equipment (the portable light) that is set on a tripod;

FIG. 5 is a perspective view of an electrical equipment system (a portable light unit) according to a second embodiment of the present invention;

FIG. 6(A) is a plan view of an electrical equipment (a loudspeaker) of an electrical equipment system (a loudspeaker unit) according to a third embodiment of the present invention;

FIG. 6(B) is an elevational view of the electrical equipment (the loudspeaker);

FIG. 6(C) is a side view of the electrical equipment (the loudspeaker);

FIG. 6(D) is a rear view of the electrical equipment (the loudspeaker);

FIG. 7(A) is a side view of an electrical equipment (an audio reproducer) of an electrical equipment system (an audio reproducer unit) according to a fourth embodiment of the present invention;

FIG. 7(B) is an elevational view of the electrical equipment (the music reproducer);

FIG. 8(A) is an elevational view of an electrical equipment (a scanner) of an electrical equipment system (a scanner unit) according to a fifth embodiment of the present invention;

FIG. 8(B) is a side view of the electrical equipment (the scanner);

FIG. 9(A) is an elevational view of an electrical equipment (an electrical fan) according to a modified form of the fifth embodiment of the present invention;

FIG. 9(B) is a side view of the electrical equipment (the electrical fan);

FIG. 10(A) is a perspective view of an electrical equipment (a range finder) according to another modified form of the fifth embodiment of the present invention;

FIG. 10(B) is a perspective view of the electrical equipment (a marking device) according to a further modified form of the fifth embodiment of the present invention;

FIG. 11(A) is a perspective view of an electrical equipment system (an electrical fan unit) according to a sixth embodiment; and

FIG. 11(B) is an exploded perspective view of the electrical equipment system (the electrical fan unit).

### DETAILED DESCRIPTION OF THE INVENTION

Next, the representative embodiments of the present invention will be described with reference to the drawings.

### First Embodiment

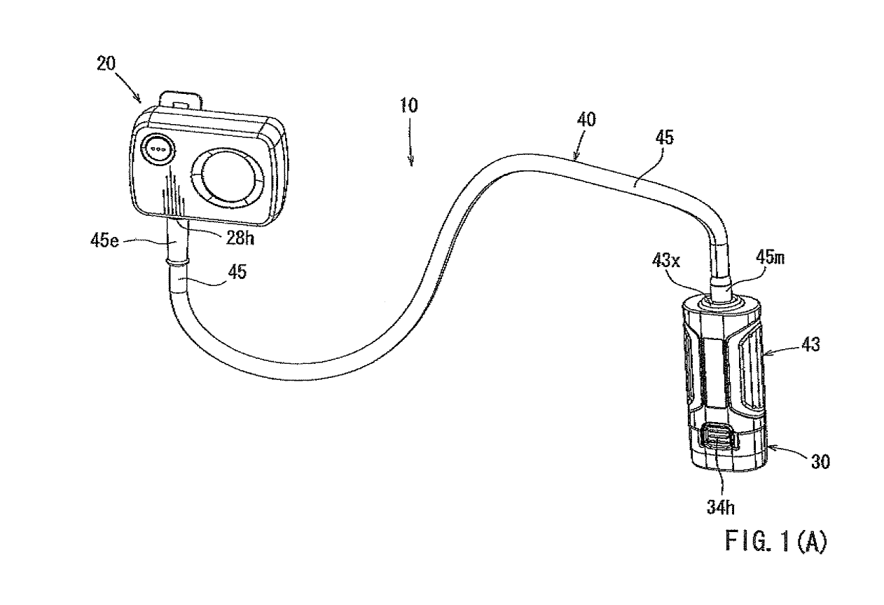

A first detailed representative embodiment of the present invention will be described with reference to FIGS. 1 to 4. In this embodiment, a battery-powered portable light unit is exemplified as an electrical equipment unit (system).

Further, front and back, right and left, and up and down in the drawings respectively correspond to front and back, right and left, and up and down of a portable light (an electrical equipment) of the portable light unit (the electrical equipment unit).

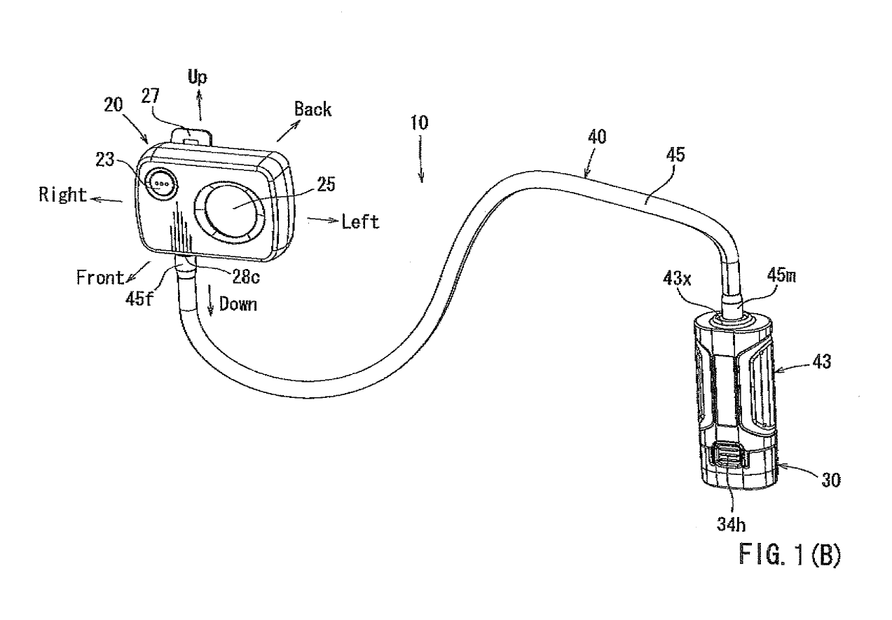

As shown in FIGS. 1 and 2, a battery-powered portable light unit 10 of this embodiment is constructed of a portable light 20, a (rechargeable) battery 30 for an electrical power tool (not shown) (which will be hereinafter referred to as a tool battery 30), and an adapter 40 electrically connecting the portable light 20 to the tool battery 30.

### <Regarding Portable Light 20>

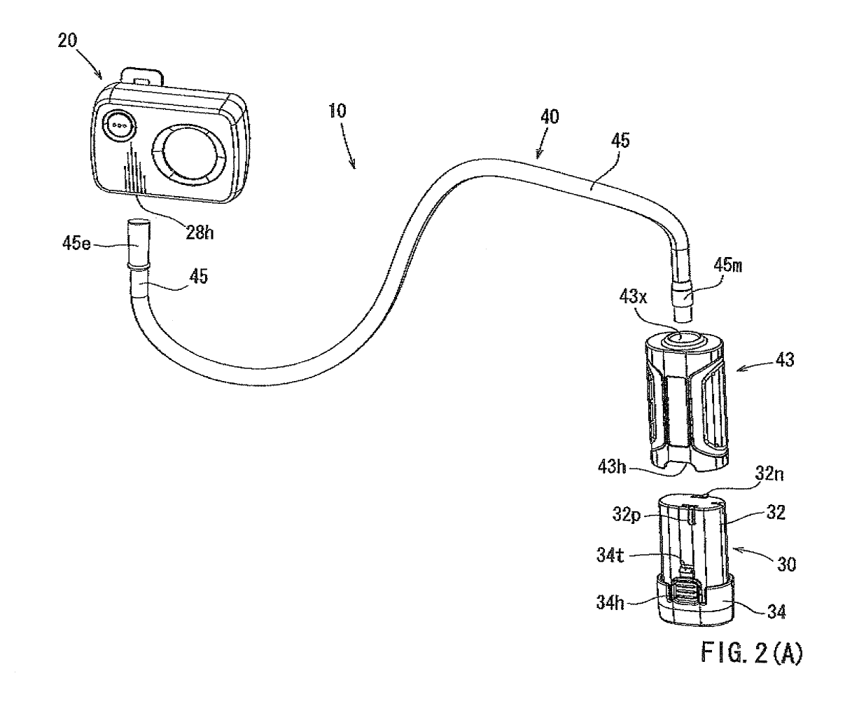

As shown in FIGS. 1 to 4, the portable light 20 has a flattened rectangular box-shaped housing 22. As shown in FIG. 3(C), the housing 22 is composed of a front housing portion 22f and a back housing portion 22b that are fitted with each other in a back and forth direction. As shown in FIG. 3(A), the front housing portion 22f has a switch opening 22h through which a switch 23 is projected. The switch opening 22h is formed in an upper right portion (an upper left portion in FIG. 3(A)) of the front housing portion 22f. Further, as shown in FIGS. 3(A) and 3(C), the front housing portion 22f and the back housing portion 22b respectively have light receiving openings 22z and 22y that are respectively formed in central portions thereof. A spherical light main body 25 is movably received in the light receiving openings 22z and 22y. Further, as best shown in FIG. 3(C), the light main body 25 is partially projected back and forth from the front and back housing portions 22f and 22b via the light receiving openings 22z and 22y. Further, as shown in FIG. 3(C), an annular guide member R is disposed in the housing 22 (the front and back housing portions 22f and 22b). The guide member R has a concave spherical surface 22x that is formed in an inner circumferential surface thereof. The concave spherical surface 22x is shaped to circumferentially surround the light main body 25 with a desired space therebetween.

As best shown in FIG. 3(C), the light main body 25 has a lens portion 25r that is formed in a front side portion thereof. The light main body 25 includes a light source or LED bulb (not shown) that is disposed therein. The light source may preferably be positioned behind the lens portion 25r. Further, the light main body 25 has a concave operating portion 25q that is formed in a back side portion thereof. Therefore, the light main body 25 can be moved or rotated via the operating portion 25q, so that a direction thereof can be changed up, down, right or left. Further, the light main body 25 has a plurality of projections 22t that are radially outwardly projected from a boundary portion between the front and back side portions thereof. The projections 22t are respectively arranged and constructed to be slidable along the concave spherical surface 22x of the guide member R when the light main body 25 is moved. Thus, the direction of the light main body 25 can be smoothly and stably changed up, down, right or left. That is, the direction of the light main body 25 can be smoothly and stably tilted or angularly adjusted. Further, the light main body 25 can be referred to as a functional portion.

As shown in FIG. 3(B), the back housing portion 22b of the housing 22 has a clip retainer member 22m that is formed in a back surface thereof. A (spring-biased) clip 27 is attached to the clip retainer member 22m. As will be recognized, the clip 27 is an attachment member to secure the portable light 20 to an attaching subject, e.g., a chest pocket of a garment of a user. In particular, the clip 27 is constructed of a lower clipping portion 27z, a pivot center portion 27c and an upper manipulating portion 27h. The clip 27 is vertically rotatably attached to the clip retainer member 22m via the pivot center portion 27c. Further, a spring (not shown) may preferably be attached between the housing 22 (the back housing portion 22b) and the clip 27, so as to bias the clip 27 in a direction in which the clipping portion 27z can be pressed against the back surface of the back housing portion 22b of the housing 22. Naturally, in order to attach the portable light 20 to the attaching subject, the manipulating portion 27h of the clip 27 is operated or pressed against a spring force of the spring such that the clipping portion 27z of the clip 27 can be spaced from the back surface of the back housing portion 22h of the housing 22.

As shown in FIGS. 1(A), 2(A) and 3(A) to 3(C), the housing 22 (the front housing portion 22f and the back housing portion 22b) has a cable insertion opening 28h into which a specialized cable 45 of the adapter 40 is introduced, which will be hereinafter described. Preferably, the cable insertion opening 28h is formed in a right portion (a left portion in FIG. 3(A)) of a bottom surface of the housing 22.

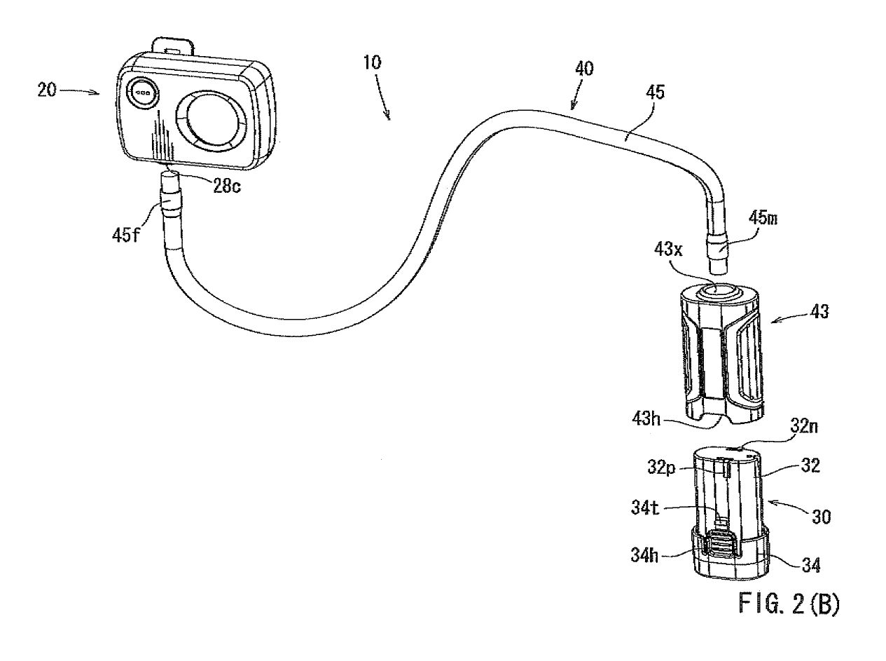

In addition, as shown in FIG. 4, the housing 22 has a threaded tripod attachment portion 29c to which a tripod 29 (an assist device that is used to attach the portable light 20 on a support post or a support base) is connected. Preferably, the tripod attachment portion 29c is formed in a central portion of the bottom surface of the housing 22. Further, examples of the assist device other than the tripod 29 are a fastener band, a magnet and a flexible leg which is shown by Japanese Laid-Open Patent Publication Number 2010-27276.

Further, as shown in FIGS. 1(B) and 2(B), the housing 22 can be partially modified. That is a cable connector 28c is provided to the housing 22 instead of the cable insertion opening 28h, so that a distal end connector 45f provided to a cable 45 of the adapter 40 can be connected thereto, which will be hereinafter described.

### <Regarding Tool Battery 30>

The tool battery 30 is constructed to be inserted into a grip portion (not shown) of the electrical power too. Also, the tool battery 30 is constructed to receive two battery elements in a size of AA cell battery therein. As shown in FIG. 2(A), the tool battery 30 is constructed of an insertion portion 32 and a cap portion 34. The insertion portion 32 is shaped to be inserted into the grip portion of the electrical power tool. The insertion portion 32 has electrodes 32p and 32n that are implanted in an insertion end thereof. The cap portion 34 has a size larger than the insertion portion 32, so as to close a battery insertion opening formed in the grip portion of the electrical power tool when the insertion portion 32 of the tool battery 30 is inserted into the grip portion of the electrical power tool. Further, the tool battery 30 has an outwardly projected engagement portion or hook portion 34t that is formed in an outer surface thereof. The hook portion 34t is positioned between the insertion portion 32 and the cap portion 34 and is elastically biased outwardly. The hook portion 34t is arranged and constructed to be snap-fitted into a hook receiving portion or recessed portion (not shown) formed in the grip portion of the electrical power tool when the insertion portion 32 of the tool battery 30 is inserted into the tool grip portion. Therefore, the tool battery 30 can be attached to the grip portion of the electrical power tool by simply inserting the insertion portion 32 into the tool grip portion. Further, the tool battery 30 has a hook manipulating portion 34h that is arranged and constructed to disengage the hook portion 34t from the recessed portion of the tool grip portion by pressing the same. Therefore, the tool battery 30 can be detached from the tool grip portion by simply pressing the hook manipulating portion 34h.

Thus, when the tool battery 30 is attached to the grip portion of the electrical power tool by inserting the insertion portion 32 into the tool grip portion, the hook portion 34t is snap-fitted into the recessed portion of the tool grip portion. At this time, the tool battery 30 is electrically connected to the electrical power tool via the electrodes 32p and 32n.

### <Regarding Adapter 40>

The adapter 40 is intended to electrically and mechanically connect the portable light 20 and the tool battery 30. The adaptor 40 is composed of an adapter main body 43 and a specialized cable 45. The adapter main body 43 has the substantially same structure as the grip portion of the electrical power tool. That is, the adapter main body 43 has a bottomless box shape and is shaped to receive the insertion portion 32 of the tool battery 30. In particular, the adapter main body 43 has a bottom opening 43h, so that the insertion portion 32 of the tool battery 30 can be inserted into the adapter main body 43 therethrough from below. The adapter main body 43 has contacts (not shown) that can contact the electrodes 32p and 32n of the insertion portion 32 of the tool battery 30 when the insertion portion 32 is inserted into the adapter main body 43. Further, the adapter main body 43 has a hook receiving portion or recessed portion (not shown) formed in an inner surface thereof. The recessed portion is arranged and constructed to engage the hook portion 34t of the tool battery 30 when the insertion portion 32 is inserted into the adapter main body 43. Therefore, as shown in FIG. 1(A), the tool battery 30 can be coupled to the adapter main body 43 by simply inserting the insertion portion 32 into the adapter main body 43. At this time, the contacts of the adapter main body 43 are electrically connected to the electrodes 32p and 32n of the tool battery 30. Further, the hook portion 34t can be disengaged from the recessed portion of the adapter main body 43 by pressing the hook manipulating portion 34h. Therefore, the tool battery 30 can be easily detached or removed from the adapter main body 43 by simply pressing the hook manipulating portion 34h of the tool battery 30.

Further, the adapter main body 43 is constructed to be coupled only to the tool battery 30 that has the same voltage as a rated voltage of the portable light 20. In other words, the adapter main body 43 is constructed to not be coupled to tool batteries other than the tool battery 30 that has the same voltage as the rated voltage of the portable light 20. Therefore, the portable light 20 can be prevented from being connected to the tool batteries having a voltage different from the rated voltage of the portable light 20. As a result, the portable light 20 can be effectively avoided from being damaged.

Further, as shown in FIGS. 1(A) and 2(A), the adapter main body 43 has a connector 43x that is provided to an upper surface thereof (a surface opposite to the bottom opening 43h).

The cable 45 is an electric wire that can be flexibly bent or deformed. As shown in FIGS. 1(A) and 2(A), the cable 45 of the adapter 40 has a proximal end connector 45m that is provided to a proximal (first) end thereof. The proximal end connector 45m can be connected to the connector 43x of the adapter main body 43, so that the adapter main body 43 can be electrically connected to the adapter cable 45.

Conversely, as shown in FIGS. 1(A) and 2(A), the cable 45 of the adapter 40 has a distal end connecting portion 45e that is provided to a distal (second) end thereof. The distal end connecting portion 45e can be introduced into the housing 22 of the portable light 20 via the cable insertion opening 28h. As will be recognized, the distal end connecting portion 45e of the cable 45 introduced into the housing 22 can be detachably connected to terminals (not shown) of the portable light 20, so that the cable 45 can be electrically connected to the portable light 20.

As shown in FIGS. 1(B) and 2(B), the cable 45 of the adapter 40 can be partially modified. That is, the cable 45 of the adapter 40 can have a distal end connector 451 that is provided to the distal (second) end thereof. The distal end connector 451 can be connected to the cable connector 28c of the housing 22 of the portable light 20, so that the cable 45 can be electrically connected to the portable light 20.

Further, the adapter main body 43 may be referred to as a battery side connecting portion. Conversely, the distal end connecting portion 45e or the distal end connector 45f of the cable 45 may be referred to as an electrical equipment side connecting portion.

### <Regarding Operation of Portable Light Unit 10>

First, the cable 45 of the adapter 40 is electrically connected to the portable light 20. In particular, the distal end connecting portion 45e or the distal end connector 451 of the cable 45 is coupled to the cable insertion opening 28h or the cable connector 28c of the housing 22. Further, the cable 45 of the adapter 40 is electrically connected to the adapter main body 43 of the adapter 40. In particular, the proximal end connector 45m of the cable 45 is coupled to the connector 43x of the adapter main body 43. Thereafter, the insertion portion 32 of the tool battery 30 is inserted into the adapter main body 43, so that the tool battery 30 can be coupled to the adapter main body 43. Thus, as shown in FIG. 1(A) or 1(B), the portable light unit 10 can be formed.

Next, the portable light 20 is attached to the attaching subject, e.g., the chest pocket of the garment of the user using the clip 27 while the adapter main body 43 (the tool battery 30) is received in, e.g., a trouser pocket of the user. When the switch 23 of the portable light 20 is operated in this condition, the portable light 20 can be turned on. Thus, the user can perform a two-handed operation in a dark place. Further, the light main body 25 of the portable light 20 can be moved or rotated relative to the housing 22 by simply operating the operating portion 25q. Therefore, irradiation directions of the portable light 20 can be easily changed, if necessary.

Further, the portable light 20 can be attached to the tripod using the tripod attachment portion 29c formed in the housing 22 in order to constantly irradiate a certain area.

### <Regarding Advantages of Portable Light Unit 10>

According to the portable light unit 10 of this embodiment, the portable light 20 can be electrically and mechanically connected to the tool battery 30 by the adapter 40. That is, the tool battery 30 can be used as an electric source of the portable light 20. Thus, the tool battery 30 can be widely used.

Further, the portable light 20 needs not contain a battery therein. Therefore, the portable light 20 can be reduced in size and weight.

Further, the distal end connecting portion 45e or the distal end connector 45f (the electrical equipment side connecting portion) can be formed to be smaller than the adapter main body 43 (the battery side connecting portion). Therefore, the cable insertion opening 28h or the cable connector 28c of the portable light 20 can be reduced in size. As a result, the portable light 20 can be reduced in size.

Further, because the distal end connecting portion 45e or the distal end connector 45f of the adapter 40 is connected to the adapter main body 43 via the specialized cable 45 (the flexible electric wire), the portable light 20 can be prevented from being applied with a weight of the tool battery 30. Therefore, the portable light 20 can have increased operability.

The portable light 20 has the clip 27 (the attachment member). Therefore, the portable light 20 can be easily and quickly attached to, for example, the chest pocket of the garment of the user. In addition, the portable light 20 can be used without holding the same by hand. Therefore, the portable light 20 can have increased usability.

Further, the light main body 25 of the portable light 20 can be tilted or rotated relative to the housing 22 by simply operating the operating portion 25q. Therefore, the light main body 25 of the portable light 20 can be easily tilted or rotated without moving the portable light 20 (the housing 22) in order to change the irradiation directions of the portable light 20. Therefore, the portable light 20 can have increased usability.

Further, the housing 22 of the portable light 20 has a flattened box shape. Therefore, the portable light 20 can be reliably and stably retained on the user's garment.

Further, the housing 22 of the portable light 20 can be attached to the tripod. Therefore, the portable light 20 can have increased usability.

### Second Detailed Representative Embodiment

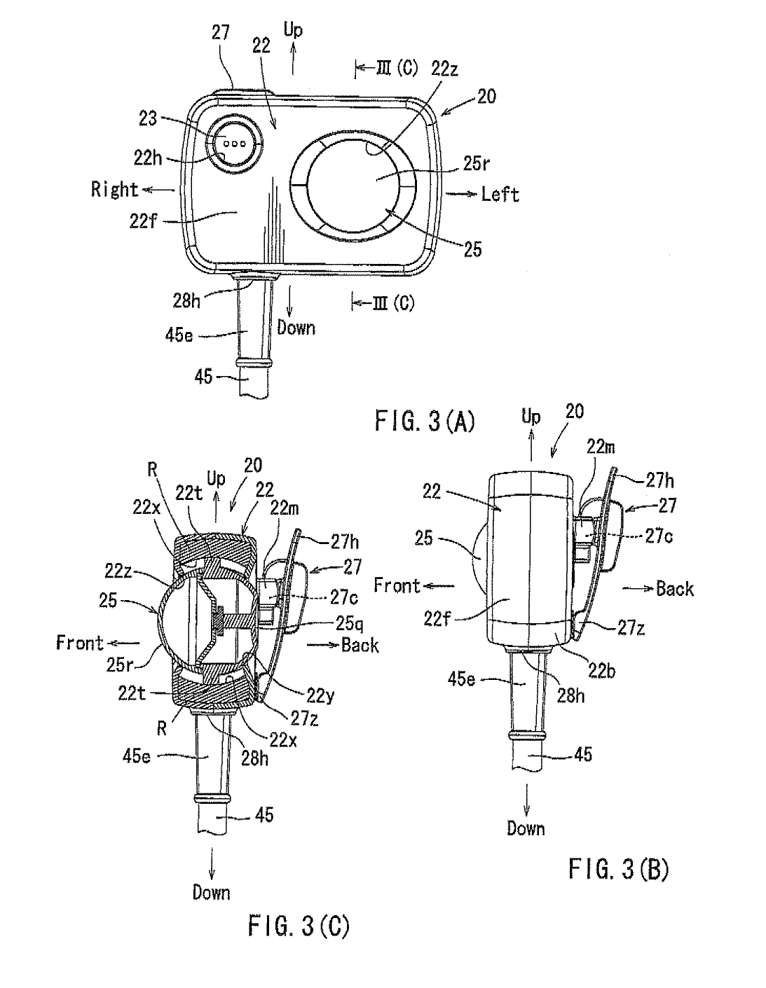

The second detailed representative embodiment will now be described in detail with reference to FIG. 5.

Because the second embodiment relates to the first embodiment, only the constructions and elements that are different from the first embodiment will be explained in detail. Elements that are the same in the first and second embodiments will be identified by the same reference numerals and a detailed description of such elements may be omitted.

As shown in FIG. 5, a battery-powered portable light unit 10′ of this embodiment is constructed of the portable light 20, a tool battery 35 and an adapter 40′.

The tool battery 35 of this embodiment is constructed to be slidably coupled to a battery attachment portion (not shown) of the electrical power tool. In order to slidably couple the tool battery 35 to the battery attachment portion of the electrical power tool, the tool battery 35 has a pair of slide rails 36 that are formed in an upper surface thereof. The slide rails 36 are arranged and constructed to slidably engage a pair of slide grooves (not shown) formed in the battery attachment portion of the electrical power tool.

Similar to the tool battery 30 of the first embodiment, when the tool battery 35 is attached to the battery attachment portion of the electrical power tool, a hook portion (not shown) formed therein is snap-fitted into a recessed portion (not shown) formed in the battery attachment portion of the electrical power tool. Thus, the tool battery 35 can be electrically connected to the electrical power tool.

The adapter 40′ has a cap-shaped adapter main body 46 corresponding to the adapter main body 43 of the first embodiment. The adapter main body 46 is shaped to cover the upper surface of the tool battery 35. Further, the adapter main body 46 has a pair of slide grooves (not shown) that are formed in an inner surface thereof. The slide grooves are arranged and constructed to slidably engage the slide rails 36. Therefore, when the tool battery 35 is moved or slid forwardly relative to the adapter main body 46 while the slide grooves of the adapter main body 46 are longitudinally aligned with the slide rails 36 of the tool battery 35, the tool battery 35 can be coupled to the adapter main body 46.

Further, the adapter main body 46 has a connector 46x that is provided to a front surface thereof. The connector 46x of the adapter main body 46 can be connected to the proximal end connector 45m of the adapter cable 45. Further, the adapter main body 46 has a hook member 47 that is attached to an upper surface thereof. The hook member 47 may function as an attachment member to secure the adapter main, body 46 (the tool battery 35) to an attaching subject, e.g. a belt of the garment of the user. The hook member 47 is capable being hooked on the belt of the user's garment. Therefore, the adapter main body 46 (the tool battery 35) can be supported on the user via the hook member 47. Thus, the portable light 20 can be effectively prevented from being applied with a weight of the tool battery 35. This means that the portable light 20 can have increased operability.

### Third Detailed Representative Embodiment

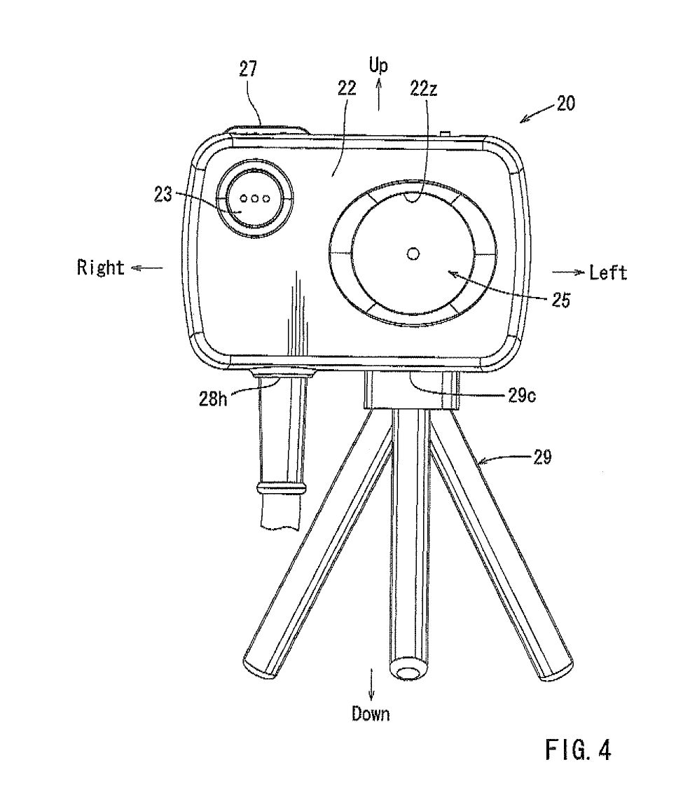

The third detailed representative embodiment will now be described in detail with reference to FIGS. 6(A) to 6(D).

Because the third embodiment relates to the first and second embodiments, only the constructions and elements that are different from the first and second embodiments will be explained in detail. Elements that are the same in the first to third embodiments will be identified by the same reference numerals and a detailed description of such elements may be omitted.

In this embodiment, as shown in FIGS. 6(A) to 6(D), the portable light 20 of the first and second embodiments is replaced with a loudspeaker 50. That is, in this embodiment, a battery-powered loudspeaker unit is exemplified as the electrical equipment unit (system). As shown in FIG. 6(A), the loudspeaker 50 has a power switch 57s that is provided to an upper surface of a housing 52 thereof. Further, as best shown in FIGS. 6(C) and 6(D), the loudspeaker 50 has a (spring-biased) clip 53 that is attached to a back surface of the housing 52. Therefore, the loudspeaker 50 can be attached to, for example, the chest pocket of the user's garment using the clip 53. Further, as shown in FIG. 6(B), the loudspeaker 50 has a speaker 55 received in an opening 52h that is formed in a front surface of the housing 52. Also, as shown in FIG. 6(D), the loudspeaker 50 has a microphone 57 received in an opening 52x that is formed in the back surface of the housing 52.

According to this embodiment, the loudspeaker 50 can be electrically and mechanically connected to the tool battery 30 or 35 by the adapter 40 or 40′. That is, the tool batteries 30 and 35 can be used as an electric source of the loudspeaker 50. Thus, the tool batteries 30 and 35 can be widely used.

Further, the loudspeaker 50 has the clip 53 (the attachment member). Therefore, the loudspeaker 50 can be easily and quickly attached to, for example, the chest pocket of the garment of the user. In addition, the loudspeaker 50 can be used without holding the same by hand. This means that the loudspeaker 50 can be used while the power switch 57s is being pressed. Therefore, the loudspeaker 50 can have increased usability.

### Fourth Detailed Representative Embodiment

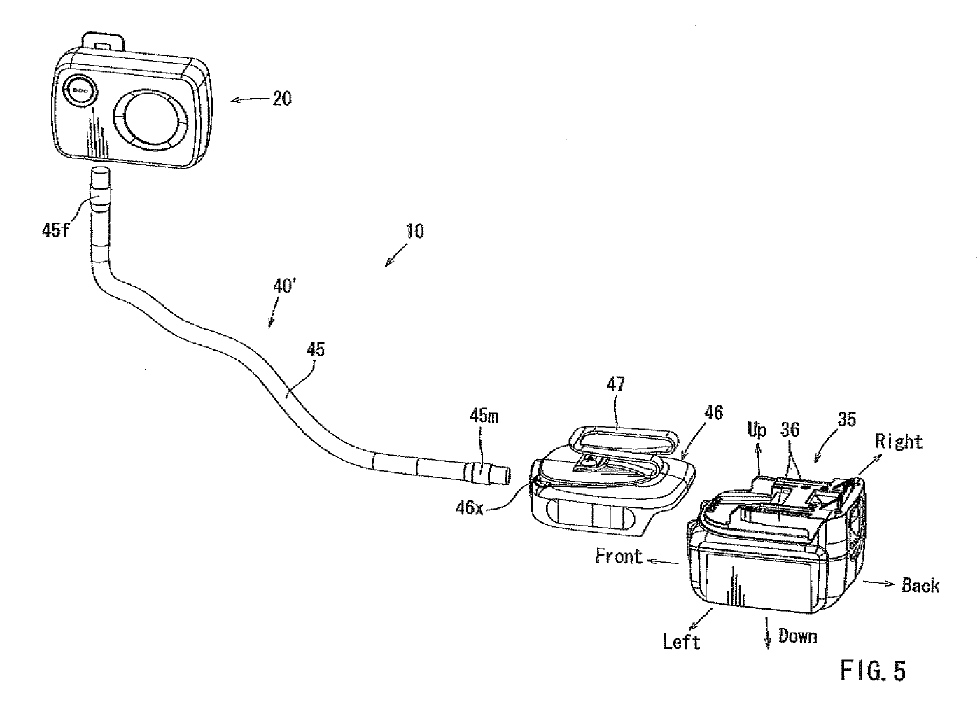

The fourth detailed representative embodiment will now be described in detail with, reference to FIGS. 7(A) and 7(B).

Because the fourth embodiment relates to the first and second embodiments, only the constructions and elements that are different from the first and second embodiments will be explained in detail. Elements that are the same in the first, second and fourth embodiments will be identified by the same reference numerals and a detailed description of such elements may be omitted.

In this embodiment, as shown in FIGS. 7(A) and 7(B), the portable light 20 of the first and second embodiments is replaced with an audio reproducer 60. That is, in this embodiment, a battery-powered audio reproducer unit is exemplified as the electrical equipment unit (system). As shown in FIG. 7(B), the audio reproducer 60 has a power switch 67 that is provided to a front surface of a housing 62 thereof. Further, as shown in FIG. 7(A), the audio reproducer 60 has a (spring-biased) clip 63 that is attached to a back surface of the housing 62. Therefore, the audio reproducer 60 can be attached to, for example, the chest pocket of the user's garment using the clip 63. Further, as shown in FIG. 7(B), the audio reproducer 60 has a speaker 65 received in an opening 64h that is formed in the front surface of the housing 62. Also, as shown in FIG. 7(A), the audio reproducer 60 has a Secure Digital (SD) card insertion slot 64u that is formed in a side surface of the housing 62. Further, the audio reproducer 60 has an input terminal 64d that is foamed in the side surface of the housing 62, so that a universal service bus (USB) flash memory, an external speaker or other such devices can be connected thereto.

According to this embodiment, the audio reproducer 60 can be electrically and mechanically connected to the tool battery 30 or 35 by the adapter 40 or 40′. That is, the tool batteries 30 and 35 can be used as an electric source of the audio reproducer 60. Thus, the tool batteries 30 and 35 can be widely used.

Further, the audio reproducer 60 has the clip 63 (the attachment member). Therefore, the audio reproducer 60 can be easily and quickly attached to, for example, the chest pocket of the garment of the user. In addition, the audio reproducer 60 can be used without holding the same by hand. This means that the audio reproducer 60 can be used while the power switch 67 is being pressed. Therefore, the audio reproducer 60 can have increased usability.

### Fifth Detailed Representative Embodiment

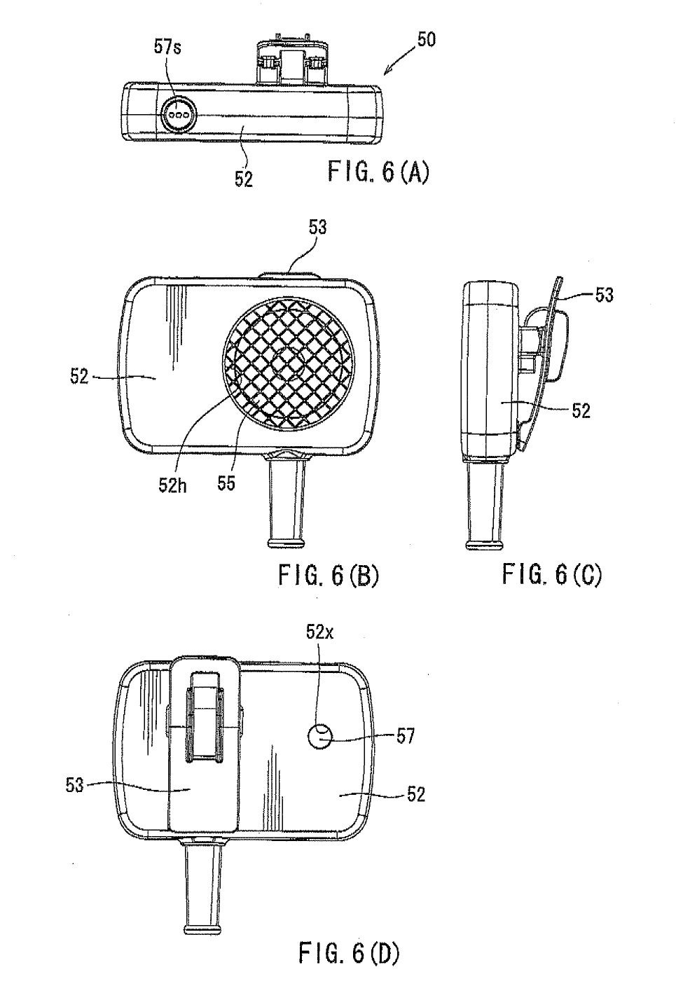

The fifth detailed representative embodiment will now be described in detail with reference to FIGS. 8(A) and 8(B).

Because the fifth embodiment relates to the first and second embodiments, only the constructions and elements that are different from the first and second embodiments will be explained in detail. Elements that are the same in the first, second and fifth embodiments will be identified by the same reference numerals and a detailed description of such elements may be omitted.

In this embodiment, as shown in FIGS. 8(A) and 8(B), the portable light 20 of the first and second embodiments is replaced with a scanner 70. That is, in this embodiment, a battery-powered scanner unit is exemplified as the electrical equipment unit (system). As shown in FIG. 8(A), the scanner 70 has a power switch 71 that is provided to a front surface of a housing 72 thereof. Further, as shown in FIG. 8(B), the scanner 70 has a (spring-biased) clip 73 that is attached to a back surface of the housing 72. Therefore, the scanner 70 can be attached to, for example, the chest pocket of the user's garment using the clip 73. Further, as shown in FIG. 8(A), the scanner 70 has a laterally elongated scanner lens 75 that is attached to the front surface of the housing 72. Further, a camera (not shown) is disposed in the housing 72 so as to be positioned behind the scanner lens 75. Also, as shown in FIG. 8(A), the scanner 70 has a laterally elongated roller 76. The roller 76 is attached to the front surface of the housing 73 so as to be positioned in parallel with the scanner lens 75. Further, as shown in FIG. 8(B), the scanner 70 has a scan start switch 74 that is provided to a side surface of the housing 72.

According to this embodiment, the scanner 70 can be electrically and mechanically connected to the tool battery 30 or 35 by the adapter 40. That is, the tool batteries 30 and 35 can be used as an electric source of the scanner 70. Thus, the tool batteries 30 and 35 can be widely used.

Further, the scanner 70 has the clip 73 (the attachment member). Therefore, the scanner 70 can be easily and quickly attached to, for example, the chest pocket of the garment of the user. In addition, the scanner 70 can be actuated when the scan start switch 74 is operated while the power switch 71 is turned on. Therefore, the scanner 70 can have increased usability.

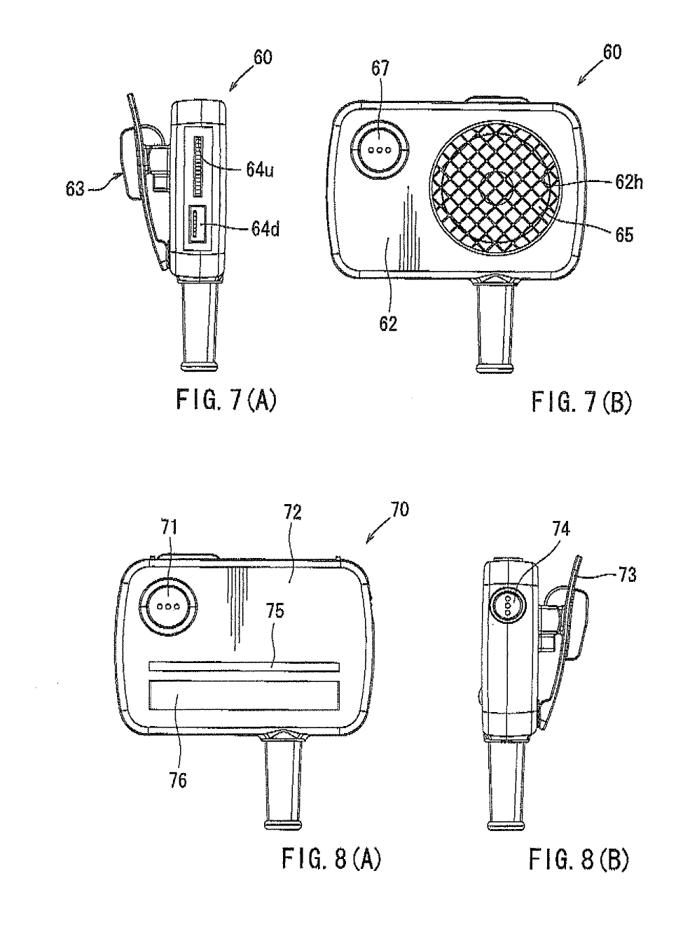

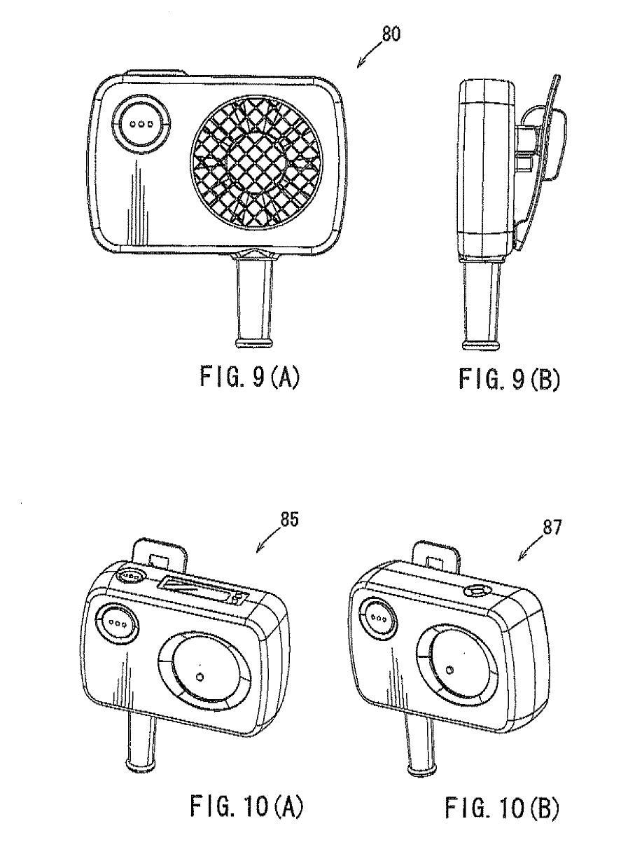

The fifth embodiment can be modified. For example, as shown in FIGS. 9(A) and (B), the scanner 70 can be replaced with an electrical fan 80. That is, the battery-powered scanner unit can be replaced with a battery-powered electrical fan unit. Further, as shown in FIGS. 10(A) and 10(B), the scanner 70 can be replaced with a laser range finder 85 or a laser marking device 87. That is, the battery-powered scanner unit can be replaced with a battery-powered range finder unit or a battery-powered marking device unit.

### Sixth Detailed Representative Embodiment

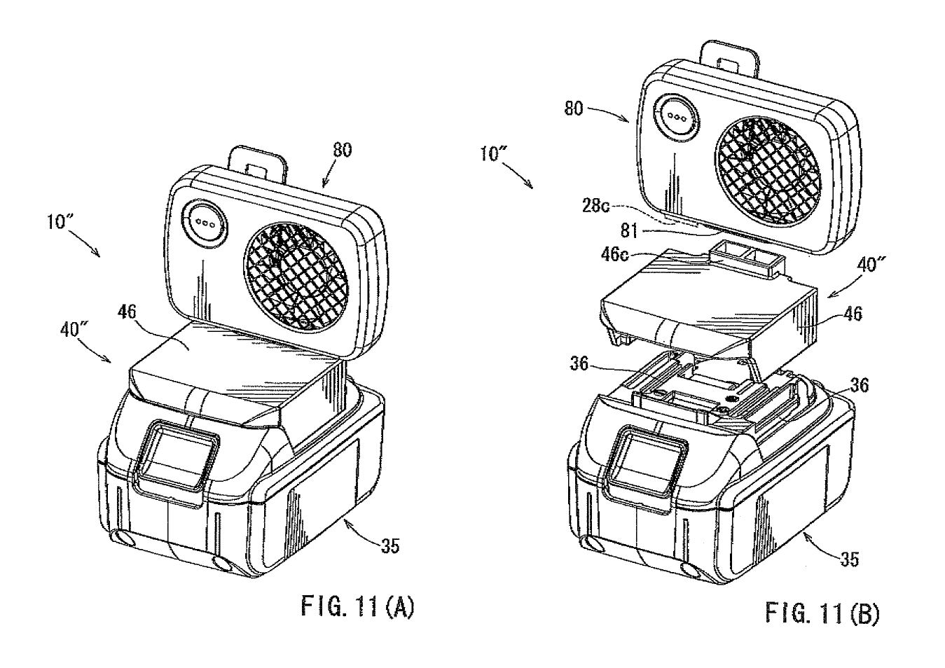

The sixth detailed representative embodiment will now be described in detail with reference to FIGS. 11(A) and 11(B).

Because the sixth embodiment relates to the second embodiment, only the constructions and elements that are different from the second embodiment will be explained in detail. Elements that are the same in the second and sixth embodiments will be identified by the same reference numerals and a detailed description of such elements may be omitted.

In this embodiment, as shown in FIGS. 11(A) and 11(B), the portable light 20 of the second embodiment is replaced with the electrical fan 80. That is, in this embodiment, a battery powered electrical fan unit 10″ is exemplified as the electrical equipment unit (system). Further, the adapter 40′ of the second embodiment is replaced with an adapter 40″.

Unlike the adapter 40′ of the second embodiment, the adapter 40″ is composed only of the cap-shaped adapter main body 46. That is, the specialized cable 45 is omitted. The adapter main body 46 has a connector 46c that is formed in an upper surface thereof. This means that the electrical equipment side connecting portion is integrated with the battery side connecting portion. Thus, the connector 46c of the adapter main body 46 can be directly connected to a connector 81 that is formed in the electrical fan 80. Therefore, the electrical fan 80 can be integrally connected to the tool battery 35 via the adapter main body 46. According to the electrical fan unit 10″ thus constructed, the tool battery 35 may function as a support base of the electrical fan 80.

Further, as shown by broken lines in FIG. 11(B), the electrical fan 80 can have the cable connector 28c in addition to the connector 81, so as to be optionally connected to the connector 46c of the adapter main body 46 of the adapter 40″ and the distal end connector 45f formed in the cable 45 of the adapter 40′. In this case, the cable connector 28c and the connector 81 may respectively referred to as a first connecting portion and a second connecting portion.

Various changes and modifications may be made to the present invention without departing from the scope of the previously shown and described embodiment. For example, in the embodiments, the portable light 20, the loudspeaker 50, the audio reproducer 60, the scanner 70, the electrical fan 80, the laser range finder 85 and the laser marking device 87 are exemplified as the electrical equipment. However, further examples of the electrical equipment are a projector, an air cleaner, a calculator, an electrical army knife, an electronic memo pad, a digital camera, a massager, a digital voice recorder, a dryer, an electrical shave; an electrical toothbrush, a pedometer, a home health checker, a radio and an insect repellent device.

Representative examples of the present invention have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. An electrical equipment system, comprising:
a battery for an electrical power tool;
an electrical equipment except for the electrical power tool; and
an adapter that is capable of electrically and mechanically connecting the battery and the electrical equipment, the adapter having a battery side connecting portion that is capable of being detachably connected to the battery and an electrical equipment side connecting portion that is capable of being connected to the electrical equipment.

2. The electrical equipment system as defined in claim 1, wherein the electrical equipment side connecting portion is constructed to be smaller than the battery side connecting portion.

3. The electrical equipment system as defined in claim 1, wherein the electrical equipment side connecting portion and the battery side connecting portion of the adapter are connected to each other via an electric wire.

4. The electrical equipment system as defined in claim 1, wherein the electrical equipment side connecting portion is constructed to be smaller than the battery side connecting portion is capable of being detachably connected to the electrical equipment.

5. The electrical equipment system as defined in claim 3, wherein the electrical equipment has an attachment member to attach the electrical equipment to an attaching subject.

6. The electrical equipment system as defined in claim 3, wherein the adapter has an attachment member to attach the adapter to an attaching subject.

7. The electrical equipment system as defined in claim 1, wherein the electrical equipment has a housing, and a functional portion that is received in the housing, and wherein the functional portion is capable of being angularly adjusted relative to the housing.

8. The electrical equipment system as defined in claim 7, wherein the housing of the electrical equipment has a flattened box-shape.

9. The electrical equipment system as defined in claim 7, wherein the housing of the electrical equipment has an attachment portion to which an assist device can be connected.

10. The electrical equipment system as defined in claim 1, wherein the battery side connecting portion of the adapter is constructed to be coupled to the battery having the same voltage as a rated voltage of the electrical equipment.

11. The electrical equipment system as defined in claim 1, wherein the electrical equipment side connecting portion and the battery side connecting portion of the adapter are integrated with each other.

12. The electrical equipment system as defined in claim 1, wherein the electrical equipment has a first connecting portion that is capable of being connected to the electrical equipment side connecting portion of the adapter in which the electrical equipment side connecting portion and the battery side connecting portion are connected to each other via an electric wire, and a second connecting portion that is capable of being connected to the electrical equipment side connecting portion of the adapter in which the electrical equipment side connecting portion and the battery side connecting portion are integrated with each other.

13. The electrical equipment system as defined in claim 1, wherein the electrical equipment is selected from the group consisting of a portable light, a loudspeaker, an audio reproducer, a scanner, an electrical fan, a range finder and a marking device.

14. An adapter that is capable of electrically and mechanically connecting a battery for an electrical power tool and an electrical equipment except for the electrical power tool, comprising:
a battery side connecting portion that is capable of being detachably connected to the battery; and
an electrical equipment side connecting portion that is capable of being connected to the electrical equipment.
